(19) United States
(12) Patent Application Publication
(10) Pub. No.: US 2003/0034874 A1
(43) Pub. Date: Feb. 20, 2003

(54) System or architecture for secure mail transport and verifiable delivery, or apparatus for mail security

(76) Inventor: W. Stephen G. Mann, Toronto (CA)

Correspondence Address: W. Stephen G. Mann, 284 Bloor Street West, Suite 701, Toronto, ON, M5S 3B8, CA

(21) Appl. No.: 09/944,442

(22) Filed: Sep. 4, 2001

(30) Foreign Application Priority Data
Oct. 29, 1998 (CA) 2,248473
Dec. 31, 1998 (CA) 2,256922
Mar. 15, 1999 (CA) 2,264973
Jul. 28, 1999 (CA) 2,280022

(51) Int. Cl. H04B 1/00; H04Q 1/00; H04B 3/00; G06T 1/00; G08B 29/00; G08B 25/00; G08B 23/00; G05B 23/00; G08B 21/00; G08C 19/00; G05B 19/00; G08B 19/00; G06K 19/00; G06T 7/00; G08B 13/00; H04L 9/32; H04L 9/14; H04Q 9/00; G06F 7/04; G06F 7/00; G06K 9/00; G06K 9/36; G06K 9/20

(52) U.S. Cl. 340/5.3; 340/5.53

(57) ABSTRACT

Anthrax is an often fatal infectious disease arising from Bacillus anthracis bacteria spores. A safe and secure mail delivery system helps to bring about a future where packages are delivered on time, crime (terrorism, etc.) is low, and morale is high. In one embodiment, biometric verification of recipients ensures packages are not delivered to the wrong recipient. Preferably the sender can visually verify the recipient's identity, as well as visually track the manner in which the package is handled. Preferably the package cannot be handled or even touched by the mail carrier, but can be handled by security forces, officers, or by the recipient, by virtue of a mail carrying housing (such as a briefcase) that can be opened by anyone except the person carrying it. Preferably the housing comprises a fingerprint scanner, or a vaccination chip reader, that can be programmed so that the carrier cannot open it. In some embodiments, a mailroom facility is provided, where persons arriving at the facility are required to undress completely before being allowed to pass into a shower room for decontamination with all appropriate decon solution. The invention includes means for preventing persons from leaving the mailroom without passing through the shower room. Preferably persons can only pass through the facility in one direction: persons first enter a clothing bagging area where they must remove all clothing, jewellery, personal effects, or other devices that could harbour contamination or chemical agents. Preferably there are dual pathways, one for men, and another for women, each comprising a bagging room, a shower area, and a vaccination area, with a seventh triage observation area, or remote video link and remotely operable passage locks, plumbing valve controls, and vaccination machines for triage personnel to supervise, observe, and administer the vaccination process.

### FIELD OF THE INVENTION

The present invention pertains generally to a mail delivery system.

### BACKGROUND OF THE INVENTION

Jay Shankman describes, in U.S. Pat. No. 4,796,311, a decontamination facility with triage room having means for viewing persons being decontaminated, access controls to water, detergent, and the like. A highway transportable decontamination facility suitable for responsing to chemical spills and other disasters is described in U.S. Pat. No. 4,858,256.

Craig Stewart of Mississauga describes, in U.S. Pat. No 5,551,102, Mobile decontamination and containment unit, decontamination shower facility with a 2 or 3 stage containment.

The divided ambulatory decon shower tents are also known in the art, for providing some degree of privacy, modesty, shelter, etc., from the outside elements, while still allowing for decon officers to ensure proper decon by patients.

Separate decon areas may be established for emergency services personnel and civilians, and there may be established separate decon areas for males and females, with male and female decon personnel at appropriate sites.

Types of decon may include passive (removal of clothing), dry, wet, etc., and provision of Tyvek (TM) or other suitable disposable clothing, shoes, etc., for decontaminated persons.

Separate plastic bags are typically provided for victims' clothing or personal property, with tracking systems to maintain accountability of any clothing or personal property.

Pursuant to the nonproliferation of WWW sites in patent disclosures, the sites are not provided here, but may be found by a. WWW search on keywords such as decon, mass decon, emergency preparedness, Weapons of Mass Destruction Act of 1996, terrorism, chemical agents, nerve agents.

Vendors, such as Modec, provide transportable decon systems, automated and self contained, that can be set-up and operated without responder/operator assistance.

With inflatable shelters, these facilities deliver heated decon solution, allowing response team personnel to process larger numbers of people.

Modec's products has twelve decon positions and can be produced with optional modesty barriers.

Other emergency preparedness products include U.S. Pat. No. 3,586,236, water cannon vehicle and U.S. Pat. No. 3,722,819, pulsed jet riot control system, and U.S. Pat. No. 3,607,780, nonlethal irritants combined with exhaust gas.

Systems for containment, security, and control of passage of persons is described in U.S. Pat. No. 4,341,165, security revolving door, U.S. Pat. No. 4,586,441, a revolving door that confines and analyzes occupants, U.S. Pat. No. 4,461,221, a system for detaining robbers on premises, U.S. Pat. No. 4,341,165, U S. Pat. No. 5,311,166 for spraying persons with dyes, water at varying temperature, or delivering electrical shock to persons, and U.S. Pat. No. 5,528,220 describes a motion detector to spray water or substance onto persons.

Decontamination may also be mandatory, as noted in the City of Edinburgh District Council Order Confirmation Act 1991 (c. xix):

(1) The Council may, if satisfied that any person, or the clothing of any person, is verminous and if such person consents to be removed to a cleansing station, cause such person to be removed to a cleansing station and cleansed as to his person and clothing.

(2) If such person does not so consent the Council may apply to the sheriff, and the sheriff, if satisfied, on oral evidence of the facts set forth in the application, and that it is expedient to do so, may make an order for the removal of such person to a cleansing station by such officer of the Council as may be specified in the order and for the detention of such person therein for such period, and subject to such conditions, as may be specified in the order, to enable him to be cleansed as to his person and clothing.

(3) The cleansing of females under this section shall be carried out only by a woman registered medical practitioner or by a woman duly authorised by the Council.

Foucault noted that every government “loves a plague” as a means of controlling civil unrest.

Additionally, the potential for suspension of civil liberties is evident even in the academic community:

The authority to compel people to remain in one location or move to another, including temporary detention;

The authority to use the military for domestic law enforcement, population control, and mass logistics;

The authority to seize community or private property, such as hospitals, utilities, medicines, vehicles, or transit centers, or to compel the production of certain goods;

The authority to compel individuals to undertake decontamination procedures, take medicines, or be quarantined;

The authority to censor and control the media;

The authority to liberalize standards for conducting searches and seizures; . . .

The authority to waive regulatory requirements on the use of certain pharmaceuticals . . . .

No reasonable person wishes to sacrifice any of these principles, but it may be necessary to do so in a real incident if lives are to be saved.

Richard A. Falkenrath, Assistant Professor of Public Policy, Kennedy School of Government, Harvard University, December 2000

### SUMMARY OF THE INVENTION

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 is a diagram showing a safe and secure mail delivery system.

FIG. 1a is a drawing of a safe and secure vaccination facility which includes a shower and a circumvention preventer.

FIG. 1b is a drawing showing certain details of the control room of the safe and secure vaccination facility, and the manner in which remote operation is facilitated.

FIG. 1c is a drawing showing certain details within the control room of the safe and secure vaccination facility, and the manner in which remote operation includes means of preventing local officials from taking over or tampering with remote observation and control features of the invention.

FIG. 2a is a drawing showing an average person entering a suspect selector.

FIG. 2b is a drawing showing an average person passing through a suspect selector.

FIG. 2c is a drawing showing an average person exiting a suspect selector.

FIG. 3a is a drawing showing a person suspected of being contaminated entering a suspect selector.

FIG. 3b is a drawing showing a person suspected of being contaminated selected by a suspect selector.

FIG. 3c is a drawing showing a person suspected of being contaminated blocked from the normal exit of a suspect selector.

FIG. 3d is a drawing showing a person suspected of being contaminated being diverted to a decon exit of a suspect selector.

FIG. 4 is a drawing showing an example of an anti complicity carrying case for an assistant mailroom clerk.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations modifications and equivalent arrangements possible within the scope of appended claims.

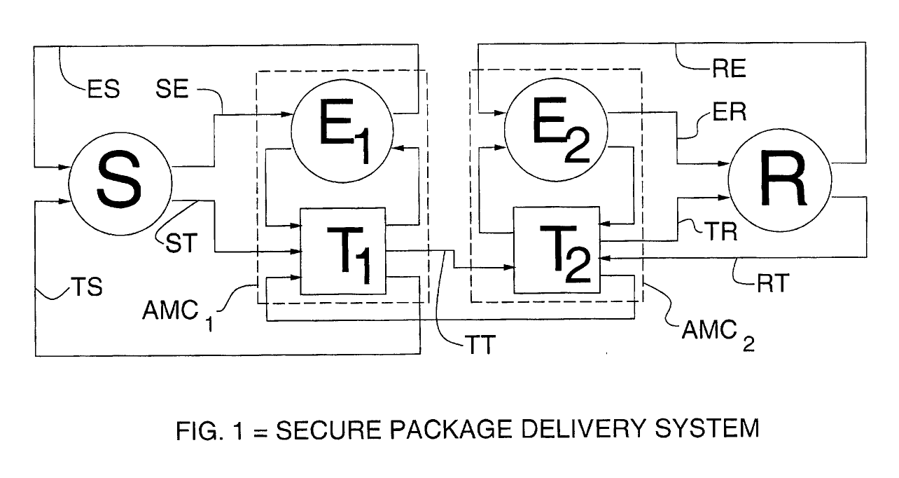

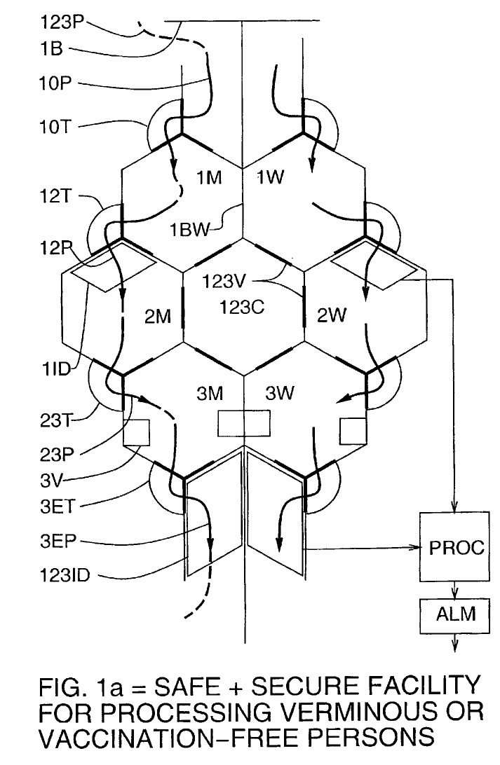

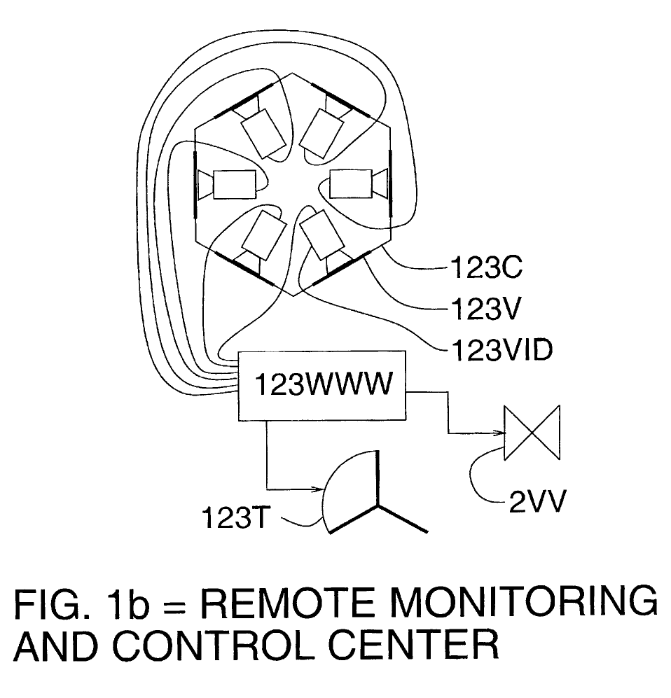

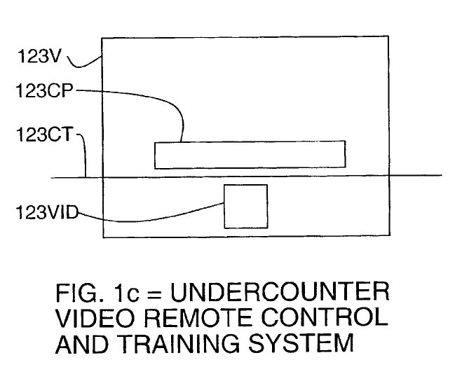

FIG. 1 shows a secure mail delivery verification system.

A sender S is screened by a cybernetic organism including an Assistant Mailroom Clerk wearing a uniform AMC₁. The uniform AMC₁ comprises two portions:

an Existential portion, E₁ which is a human interface intended for a wearer of the uniform; and

a Technology portion, T₁ which is usually embodied as some form of wearable computer, wireless communications infrastructure, etc.

The sender S can communicate directly with a wearer of the uniform, by way of the Existential portion, E₁, or indirectly by way of the Technology portion, T₁.

The sender S may be screened for anthrax or other chemical agents, or may be screened for disease. For example, the Technology portion, T₁ may include a scanner that the Assistant Mailroom Clerk can press against the sender's left shoulder to scan for a cowpox vaccine scar. The scar can be automatically matched against a known database of vaccine scars. This method of sender screening is practical because mandatory vaccinations are often done in standardized locations, using the so-called “scarification” method. Scarification practices in common use provide clear evidence, by way of marking the body in a known location, of compliance with mandatory vaccination requirements. Preferably the scanner comprises an SMT-100 ScarScan (TM) device manufactured by EXISTech Corporation which has a flat surface for pressing against the skin, to constrain the search space to a two dimensional pattern matching problem of automorphisms (or cross morphisms) over the Euclidean group of coordinate transformations in the plane. Alternatively, technologies used for fingerprint scanners can also be applied to scanning vaccination scars.

The ScarScan (TM) system ensures compliance because the system incorporates an automated refusal to accept packages from verminous unclean disease carrying persons. In this manner, the Assistant Mailroom Clerk is equipped well along the “will not, may not, cannot” hierarchy, and may appear to be, or actually be just following orders, rather than personally refusing to accept a package from a verminous unclean disease carrying person.

In this manner, the sender is required to be free of smallpox or similar disease. Additionally, packages themselves may be screened for trace amounts of chemical or biological agents such as anthrax spores.

The uniform may also include Personal Protective Equipment (PPE), safetyglasses with EyeTap (TM) technology, or other elements of safe business practice.

Another uniform, or the same uniform at a different time, is denoted by AMC₂. Thus AMC₂ may denote the same uniform worn by the same Assistant Mailroom Clerk at a later point in time, or it may denote the same uniform worn by a different, Assistant Mailroom Clerk at a later point in time, or it may denote a different uniform worn by the same Assistant Mailroom Clerk at a later point in time, or a different uniform worn by a different Assistant Mailroom Clerk at a later point in time.

Uniform AMC₂ is worn while a package is delivered to a Recipient, R. Preferably the uniforms; especially the uniform AMC₂ has some kind of instrumentation to facilitate close tracking of the packages carried by the wearer of the uniform. This instrumentation may include position sensing and tracking technologies, such as Global Position System (GPS) devices. Preferably the uniforms, especially the uniform AMC₂ also include at least one security camera. Preferably there is also a wireless communications infrastructure for the camera so that a person sending a package can track the progress of the package visually, in addition to tracking the physical coordinates of the package.

Preferably there is a video capture, transmission, and archive capability, so that a sender can visually review the manner in which a package was treated, how carefully it was handled, and, most importantly, how it was received, and by whom it was actually received, and the way in which it was received.

Traditionally, packages are signed for, with some kind of pen-based scribble, or scrawl, and often this is the only evidence of package receipt by a specific individual. Any recipient could write or scribble anything, which may or many not necessarily have any actual correlation to the true identity of the recipient. Thus the only thing the sender can really be sure of, is that the address is correct, since anyone working at, or pretending to work at, the receiving address could intercept the package on behalf of the true intended recipient.

The video camera of the invention helps prevent or deter fraudulent package interception, as well as document true and proper package reception.

Additionally, a biometric device, such as EXISTech Corporation's Recipient Biometrics (TM) system, may be used. An example of such a system is EXISTech Corporation's briefcase that cannot be opened by the person carrying the briefcase. Such a briefcase may comprise a portion of uniform AMC₂. In this way, the Assistant Mailroom Clerk wearing uniform AMC₂ cannot tamper with the package. Only a person other than the wearer of uniform AMC₂ can open the briefcase. This ensures that the recipient, or anyone claiming to be a security guard or customs official wishing to examine the package, is screened in some way. It is doubtful, therefore, that anyone pretending to be a security guard or customs official (e.g. perhaps an escaped convict wearing a stolen police uniform) would continue to insist the wearer of uniform AMC₂ submit to a search, once that person realized that the wearer of uniform AMC₂ cannot open the briefcase holding the secure mail, or the like. The Recipient Biometrics system also moves the situation out far enough along the “will not, may not, cannot” continuum, that the wearer of uniform AMC₂ is not considered disrespectful of authorities wishing the wearer to submit to being searched.

Recipient Biometrics (e.g. means for Biometric Recipient Verification) is archived through an Existential component, E₂, as well as a Technology component, T₂, borne by the uniform AMC₂. A recipient biometric element, such as a fingerprint scanner, is typically part of the Technology component, T₂.

Assuming that the package, inside a secure package carrier (briefcase, carrying case, or the like), arrives at the destination, the recipient may, if he or she desires, open the package in the presence of a wearer of uniform AMC₂ so that the contents of the package become part of the documented visual record, by way of the video camera of uniform AMC₂.

In FIG. 1, the informatic signal flow path ES carries information from the Existential component, E₂ to the Sender S, and may comprise a direct communication means such as speech, through an opening in the uniform AMC₁ through which a wearer may speak. This opening may be airtight but remain acoustically transparent.

Alternatively, the wearer may talk to the sender, S, by way of communications path TS, for example, by body worn loudspeakers fed by a signal acquired from a microphone in the wearer's uniform AMC₁. Microphones on the outside of the wearer's uniform AMC₁ can facilitate path ST back to the wearer's Technology component T₁.

Likewise, acoustically transparent openings in uniform AMC₁ may allow the wearer to hear the sender directly by path SE. A visual path SE may also be afforded by a transparent visor in uniform AMC₁. However, it may be desired that, under program control., path SE can be disconnected, e.g. by an electric shutter on the transparent visor to rendor it opaque, or the like. This feature may prevent spam or other visual detritus from contaminating the wearer of uniform AMC₁, and may also prevent complicity of the wearer of uniform AMC₁. If the wearer cannot see or hear the sender S, but for the mediation through the technology component T₁, along path TS and path ST, or if at least the sender S has the impression of an inability to be seen or heard but through the technology component T₁, it is unlikely the sender would attempt to propose criminal activity.

Path ST can include information flow from a sender screening device such as a vaccine scar scanner.

A recording capability can give path TT a transformation from the present time component T₁ to the future component T₂ Alternatively, path TT may simply be a communications channel to another person wearing uniform AMC₂. Thus the interaction may be with a single clerk, or from one clerk to another.

A path from a package delivery clerk wearing uniform AMC₂ may be established by both direct and mediated communication. Signal flow path ER may similarly comprise acoustic openings in uniform AMC₂, whereas signal flow path TR may comprise loudspeakers incorporated into uniform AMC₂.

Signal flow path RE from recipient to existential component E₂ may be made by way of acoustic openings in uniform AMC₂ as well as visual openings through which the wearer can see.

Signal path RT may include the use of cameras, microphones, fingerprint scanners, and the like, used by a wearer of uniform AMC₂.

FIG 1a shows a, vaccination facility suitable for ensuring that persons handling packages, or sending packages, or police officers wishing to search packages, or other officials wishing to handle packages, are free of disease. Men enter the facility and pass through the facility along the path 123P. There is a separate entrance for women, who follow a similar path through the system. A baffle 1B prevents men who are arriving at the facility from seeing into the women's bagging room 1W. Baffle 1B also prevents women, arriving at the facility, from seeing into the men's bagging room 1M.

Persons following path 123P first pass through turnstile 10T along path 10P which is denoted by a solid line. Turnstile 10T prevents men from leaving bagging room 1M once they have arrived there. The only way to get out of bagging room 1M is by passing through another turnstile 12T.

It is assumed that men in room 1M might not have been vaccinated such that they must be vaccinated. The underlying assumption is that those arriving at the facility must be vaccinated. All those suspect of possibly having been contaminated are sent to the facility for vaccination because it is better for a person to be safe than disease-carrying. It is far worse to leave a person and do nothing, than it is to vaccinate everyone who might come in contact with a suspected chemical or biological agent.

The invention includes means for preventing men from leaving bagging room 1M until they strip completely naked, and deposit all of their clothing and personal effects into a bag. A row of bag dispensers along wall 1BW, in room 1M, allows several men to undress simultaneously, each of them undressing in front of their respective bag dispenser, and putting their clothing and personal effects into bags, and obtaining a claim check from their bag dispenser. Bags are sealed and travel from the bagging room along a conveyor. Two separate bags may be provided for each person, one for washables (e.g. clothing) and another for nonwashables, such as wallet, personal organizer, wearable computer, or the like. In this way, persons using the facility may feel better about being able to separately bag their valuables, and clean out their own pockets into one bag, and put just clothing into the other. This also makes the decontamination of the clothing easier since it is already sorted, and eliminates the need for a hazmat (hazardous materials) team to sort through the possibly contaminated clothing.

Preferably the men each receive a triage tag, or wristband, which can be automatically dispensed by a bagging machine that also automatically seals each bag as evidence. A pushbutton on the bag dispenser also doubles as a fingerprint scanner to seal the clothing as evidence that traces back to a particular individual. Note that terrorists could well be the first of the victims of a chemical spill. Once naked, men pass through turnstile 12T along the path denoted by solid line 12P, into shower room 2M. Immediately after passing through turnstile 12T, they are identified by an identifier 1ID. In the preferred embodiment, identifier 1ID is a foot scanner, comprising a vitrionic floor surface, wherein total internal reflection is used to image the footprints of those walking upon the vitrionic surface A vitrionic surface is one made of glass, or glasslike materials, and having suitable optical properties through which a footprint image may be obtained. Preferably the vitrionic surface is large enough that persons cannot step over it. Requiring each person to place a foot in a specific location would slow down the mass decon process. Therefore, the vitrionic surface will be relatively large, with the assumption that at some point in time, each person will step on it at least once. Because of the large size of the vitrionic surface, relative to a footprint image that may land anywhere thereupon, a high resolution sensor array is used to image the entire area, and a simple computer program searches the area for footprints (note that there may be several footprints from more than one person). Therefore a high resolution sensor, such as that from a Kodak DCS460 camera, is used, together with a SCSI interface to a dual Pentium (TM) computer having relatively fast processors.

Typically the system captures the identifying feature of a footprint more than once for each person, so these are compared and pruned to select the best one, or combine multiple instances of the same into a higher resolution single image for each.

The choice of location for identifier 1ID is just inside room 2M, immediately following turnstile 12T, because that is the earliest point in the system that there is certainty that shoes will be absent.

In room 2M, men are decontaminated by high pressure water, preferably with pressure not less than 75 PSI. The shower room is subdivided into a deluge section, a spray section., and a rinse section, with appropriate solutions for each of these.

After showering, men pass through turnstile 23T along the path denoted by solid line 23P. At this point, they are in vaccination room 3M, where jets of warm air dry them off, so that they can proceed to be vaccinated.

There men will receive a free vaccination and tyvek jumpsuit.

To receive their free vaccination, each person inserts his right hand into the vaccinator, 3V, palm down, until it locks in place. Since vaccination is alleged to be voluntary (unless a person refuses to be vaccinated in which case it is compulsory) persons need to agree to the Terms and Conditions of Use for the vaccination, so the hand will be lowered onto a Bible so that the person can recite an oath into a videoconferencing system for a decon officer or triage officer to observe and record. In order to prove to the person receiving the vaccination that the Bible is authentic, the participant will be able to see it. For now he sees the Bible, through a glass, clearly, open at the first book (Genesis) prior to insertion of the right hand, and then the Bible will drop down and open at the last book (Revelation) after he finishes reciting his oath. A small microchip-controlled time-release vaccine capsule will be injected into his right hand, and the wrist strap will be automatically removed. When the hand is unlocked from the vaccinator, 3V, a tyvek jumpsuit will automatically be dispensed. The participant may put on the jumpsuit and proceed to the exit (the fourth and final turnstile), turnstile 3ET, which will be unlocked by way of the microchip vaccine implant in each participant's right hand. Preferably the turnstile is designed so that only one person can fit through at a time, so that it is impossible for anyone to escape from the facility without receiving a mandator (allegedly optional) vaccination.

Thus the user simply inserts the right hand into the reader to view the Terms and Conditions, and clicks on “Agree” in order to download a free exit license! (This principle of operation is quite similar to the SeatSale framework for downloading a free seating license.)

The exit path is denoted by solid line 3EP through turnstile 3ET. Upon exit, men pass over a second identifier, 123ID, which ensures that anyone who enters shower room 2M also exits the system If there is an excessive delay between when a certain individual enters and exits the system, as might arise if a person failed to cooperate in passing through the system in a timely manner, an alarm 1123ALM is sent to staff at a triage or control center. The tracking of persons through the system is done by a computational information processor 1123PROC.

Participants proceed now to the baggage claim area to receive their clothing and personal effects. Baggage claim is made by inserting the right hand into the reader. Each person's bag (personal effects) will be dispensed automatically. Persons are free to keep the tyvek jumpsuit (as a memento of the free health care that they have received) or change back into their street clothing.

Toilet and changeroom facilities are provided at the bag claim area. To enter th e restroom/changeroom area, persons simply insert their right hand into the reader, in order to download a free restroom/changeroom usage license. The free vaccine chip can also be used to enroll in free give-aways, and many other free services.

The women's path through the system operates similarly, and men and women exit on separate sides of a central partition running down the center of the exit corridor.

The invention includes certain features for dealing with persons who are unwilling or unable to comply with the requirements of the vaccination process. Turnstiles 10T, 12T, 23T, and 3ET ensure a one way flow through the system. Additionally, the turnstiles have two modes of operation, one way and zero-way. In the one-way mode, persons can only pass in one direction. In the zero-way mode, persons cannot pass in either direction. The selection between these modes can be done from a central triage room or control center. Two additional modes, a reverse-way and a both-way, mode, may also be selected for emergency situations, such as allowing some persons back out of the bagging room in the event that someone in the bagging room becomes violent and threatens the safety of other persons therein, or in the event of a fire. In the event of a fire, the turnstiles are preferably responsive to the fire alarm by defaulting into the special both-way mode (free-turning either way). A sign reading “emergency turnstiles unlocked by fire alarm” may also be displayed in the bagging room or the like.

By way of example, turnstile 10T allows several men to enter bagging room 1M until the bagging room 1M has reached its capacity. At this time, turnstile 10T locks so that nobody else can enter (or leave). The turnstile is controlled manually by staff remotely monitoring the facility, or automatically be way of occupancy detectors, person counters, machine vision systems, or the like. When the first group of men have bagged their clothing and personal effects, and have passed into shower room 2M, the bags are conveyed out of room 1M and the turnstile unlocks to accept the next group of men. Persons form a queue (line) outside the facility.

It is expected that some persons may panic once they discover that the removal of clothing or vaccination is a requirement of passing through the facility. Accordingly, one or more turnstiles further upstream, at a point before men and women are separated, may be included to keep persons from fleeing from the facility when they discover that men and women are being separated. In this case, the queue will pass through these one or more turnstiles, until persons reach the facility. In this way, by the time they observe the first clue (separation of men and women) that undressing may be involved, they are already locked in by way of at least one upstream turnstile.

Persons may try to pass through turnstile 12T without first undressing, or may try to bring weapons or other items into room 2M. For this reason, turnstile 12T is the most important in the system, because it is the place where an undressing requirement may be imposed and at which time a person may still be carrying weapons. In one embodiment, an ultrasonic sensor determines whether or not clothing is present, and automatically allows naked persons to pass through, while blocking the passage of anyone wearing anything that can absorb ultrasonic waves significantly (e.g. cloth). However, it is essential that persons also remove wedding rings, wearable computers, and other devices that could harbor chemical contaminants. Moreover, if one of the men in room 1M becomes violent, and produces a weapon, such as a gun, or a munition such as a textbook on discrete mathematics of cryptography or floppy disk with encrypted material, he may pose a threat to the safety of others in room 1M.

If one of the men in room 1M threatens others with a weapon or munition, or number theory, and demands passage through turnstile 12T, he will be allowed to pass through the turnstile 12T and be apprehended downstream. Turnstile 10T will then be remotely switched into reverse-way mode, so that the other men can leave room 1M and nobody else can enter until the violent person is apprehended downstream.

If a person becomes violent with a knife, rather than a gun or munition, turnstile 12T may allow the person to pass one third of the way, and then turnstile 12T will then lock so that the person is trapped in the turnstile itself. This makes it easier for a hazmat team to apprehend the violent person without risk of having their protective slits cut open in a struggle, which would expose staff to the risk of contamination, if the perpetrator were free to run around in a larger space such as room 2M.

It is expected that any violence or uncooperative behaviour would most likely happen in the bagging room 1M, so at least this room is monitored either through a viewing window or by way of closed circuit television, or the like, by staff in a control room who can manually control the turnstiles, or manually override the turnstiles if they are being automatically controlled.

Spray jets may be included in the bagging room to chemically subdue misbehaviour therein with teargas, pepper spray, or other chemical substances, especially in situations where all but one person have cooperated and passed into shower room 2M. In this case, staff wait until all cooperative persons have left shower room 2M, and are safely beyond any risk of being adversely affected by chemicals used to subdue a person in room 1M.

If a straggler in room 1M merely refuses to undress, but is not violent, he may be sprayed with a mild irritant rather than pepper spray. Preferably the irritant is selected so that it induces severe itching, or the like, under pressure of clothing, but otherwise has no effect. Clothing soaked in such a substance is extremely uncomfortable, whereas areas of the body such as the hands and face are not affected. In this way, a straggler will quickly understand that the source of irritation can be removed by removal of clothing. Even ordinary water exhibits this property to some degree (e.g. spraying a straggler with plain water makes wet clothing feel uncomfortable, whereas the water dries off the hands and face).

FIG 1b depicts a remote mailroom monitoring system, comprising six video cameras 123VID, connected to a web server 123WWW which allows staff to remotely monitor the facility. Such a situation may be useful when large numbers of the facilities are installed in various hospitals, airports, and other places where mass casualties could arise. In this way, a single emergency preparedness center, at a single remote location, can be staffed at all times, in order to deal with the possibility of an outbreak of disease or dissent at any location where a facility is installed.

Staff at the remote location monitor each of the six rooms 1M, 2M, 3M, 1W, 2W, and 3W, depicted in FIG. 1. If desired, rooms 1M, 2M, and 3M may be monitored by male staff, and, in a separate monitoring facility, rooms 1W, 2W, and 3W may be monitored by female staff.

Remote staff may also control the turnstiles 123T and various features of the plumbing, such as solenoid valves 2VV. Turnstiles 123T and plumbing, such as solenoid valves 2VV are run from the same web server 123WWW, as Common Gateway Interface (CGI) scripts in the CGI bin directory of the computer on which web server 123WWW runs. A satisfactory server comprises a rackmount Personal Computer (PC) having six PCI slots, with a Linux Media Labs LML33 video capture card in each slot, and an Apache web server running under the GNU Linux operating system. The GNU Linux operating system is required for reliability since there may not always be someone there at each facility to reboot the computer every few minutes as might be needed if a Win95, 98. or NT system were used.

FIG 1c depicts both local and remote operation. So far, two systems have been de scribed, one being locally operated, and the other being remotely operated. However, it might be desirable to operate the facility locally, while having remote expertise also monitoring the operations. For example, during an outbreak, staff at a remote monitoring site, skilled in the art of handling mass casualties, will take immediate charge of the situation, and at the same time, local authorities will be dispatched to the facility where the outbreak or dissent occurred.

It is expected that some local authorities may not necessarily be well versed in the art of handling mass casualties, in which case the remote staff will serve as remote experts to advise the local authorities in how best to handle a given situation, especially how to handle irregularities, such as patients who refuse to undress, or become violent or panic stricken when faced with the prospect of a mandatory vaccination requirement.

Moreover, even when local authorities are experts, the remote monitoring capability may be used to produce training videos for archival in the remote monitoring site. These training videos could be used to train new staff at the remote site.

Alternatively, video may be captured and archived on the web server 123WWW at each local site, for referral by authorities, especially in tie event of violent behaviour where evidence is needed locally.

In either case (local or remote storage of training videos), privacy is of the utmost importance, so there should be separate servers or directories, one from rooms 1M, 2M, and 3M, for viewing by male trainees, and another from rooms 1W, 2W, and 3W, for viewing by female trainees.

In the control center 123C, there is a counter with countertop 123CT. The countertop 123CT runs around the perimeter of the control center 123C. Upon the countertop 123CT there rests a control panel 123CP. Control panel 123CP has various switches and potentiometers that control different aspects of the system, and controls for valves, turnstiles, decontamination solution selection, and the like.

Each of the six viewing windows 123V extends beneath the counter, and video cameras 123VID are mounted underneath the countertop 123CT. The area beneath the countertop 123CT may be sealed off, to prevent tampering by local officials who might try to take control of the control center 123C by preventing viewing from the remote control station. Preferably the remote control station can override control panel 123CP by way of web server 123WWW. Web server 123WWW is also secure from tampering by local officials. Accordingly, in a dispute between local officials and remote experts, the remote experts shall have final say.

Alternatively, the video cameras may be housed separately, above the countertop, or within the rooms themselves. Preferably they are situated such that the remote staff has approximately the same perspective viewpoint as the local staff, so that communications between local and remote staff will make reference to the same depiction of reality.

In another embodiment of the invention., an entire separate facility for men (all six rooms) and women (another six room facility) may be used, where one path is for entrance and the other path for exit.

This arrangement could be used for a mailroom, where persons handling the mail enter through a decon shower and also exit through a decon shower, to prevent anthrax spores or the like from entering or leaving the mailroom. In this case wall 1BW has a set of two way openings, or lockers that open on both sides, where clothing is left on the way in, and picked up on the way out. For example, men would enter through the men's pathway of FIG. 1a, but men would exit backwards through the wvomen's pathway of FIG. 1a.

A separate identical facility would be used by women.

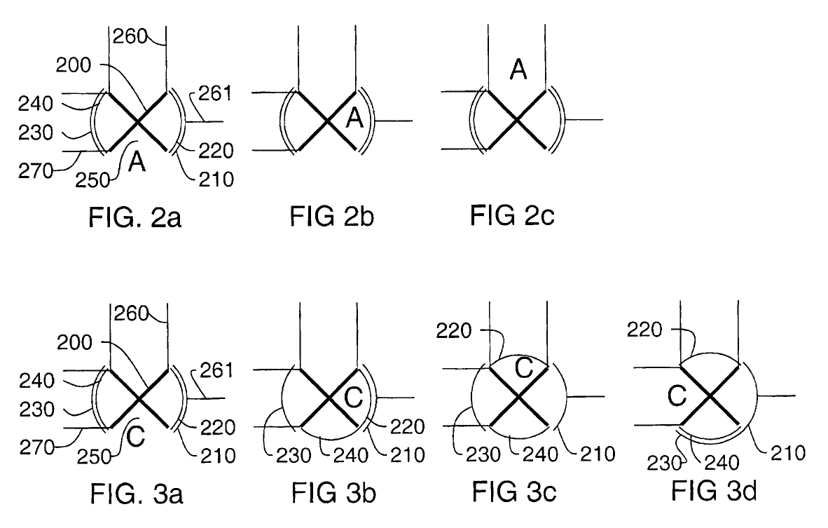

FIG. 2a depicts a suspect selector comprising a turnstile 200, with four panels, a fixed panel 210, and three movable panels 220, 230, and 240.

An average person, A, who is normal (e.g. free of being suspected of possibly having the chance of maybe being contaminated or verminous), passes through the turnstile quickly and effortlessly without delaying persons going through. Such efficient traffic flow means that average persons enter opening 250, and move quickly to exit 260, while being blocked by wall 261 and decontamination corridor 270, so that everyone, including normal people, need to go through the turnstile.

FIG. 2b depicts a normal person having rotated the turnstile by an angle of π/2 (90 degrees, or a quarter turn).

FIG. 2c depicts a normal person having rotated the turnstile by a half turn, and appearing at the exit

FIG. 3a depicts a person, C, suspected of possibly having the chance of being contaminated or a person who is suspected of being verminous, just entering turnstile 200. Panel 240 is now locked to turnstile 200 so that the two will next travel together.

FIG. 3b depicts a person, C, suspected of possibly having the chance of being contaminated or a person who is suspected of being verminous, having rotated the turnstile by a quarter turn. Panel 240 swings around with turnstile 200 to prevent new persons from entering, and to also partially unblock the path to decon corridor 270. Panel 220 latches to turnstile 200 so that it will next move with turnstile 200.

FIG. 3c depicts person C having turned the turnstile a half turn, carrying panel 220 with turnstile 200. This prevents person C from escaping through the exit 260. Panel 230 now latches to turnstile 200 and will next travel with turnstile 200.

FIG. 3d depicts person C having turned the turnstile three quarters of a turn, carrying panel 230 with it. This clears the way for suspected person C to head out into decon corridor 270 leading to a decontamination facility or cleansing station.

In this way verminous or unclean persons, or persons suspected of being unclean, or persons showing symptoms of contamination or chemical exposure (e.g. persons exhibit strange or abnormal behaviour) can be diverted to a cleansing or processing station without the need for any human intervention.

The suspect selector may be activated by scanning for a vaccine chip implant, and diverting persons lacking vaccination to a cleansing station or vaccination facility.

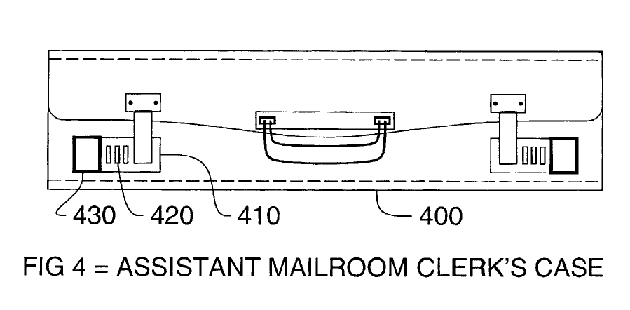

FIG. 4 shows a package carrying case, comprising a briefcase 400 to be carried by a delivery clerk. Within the context of the business method disclosed herein, the briefcase 400 is preferably at least partially owned by an entity other than the person carrying it. If the briefcase is purchased by the carrier, the carrier may choose to sell a partial interest in the briefcase in order to be at least partially bound to freedom from being forced to submit to a search of the case. In this way the carrier can truthfully say it is not (entirely) his or her briefcase. Such a business arrangement can work as a freetime corporatizer. The briefcase is symbolic of business, and is therefore an ideal article to use for freetime corporatization. Additionally, an individual carrier can request, through the business model of this invention, employment as a courier to deliver a sheet of paper from a mailroom to where ever he happens to be already going (e.g. for a vacation, or the like). This request therefore can make the briefcase 400 mean business. Preferably the piece of paper is a confidential document and preferably the individual carrier is bound not to disclose the confidential document to strangers. Accordingly, the briefcase 400 has locks 410, with or without thumbwheel combination lock inputs that comprise a deniability 420 The deniability 420 provides the individual carrier with a convenient way of forgetting the combination number so that the carrier needs remote assistance from his mailroom to open the briefcase. Thus when required to submit to a search of the briefcase 400 (such as by an official) the carrier provides the official with a submission interface which takes the form of two fingerprint scanners 430.

This feature ensures submissivity reciprocity, in the sense that the carrier can only submit to a search if the searcher submits to being fingerprinted. Along the “will not, may not, cannot” continuum, this arrangement is quite far along this continuum.

The system has at least one mode of operation in which the briefcase cannot be opened by the carrier. For example, there may be two combination numbers, a first one which opens the briefcase and another which additionally requires thumb prints from a person other than the carrier to open the briefcase. If the carrier conveniently forgets the first combination number, then the carrier needs the official wishing to conduct a search to assist by providing additional thumb prints to open the case. This need is accomplished by previously storing thumb prints by the briefcase, so that the system rejects the carriers thumb prints. This indirectly allows the carrier to force the official to be fingerprinted in order to fulfill the official's request for a search of the case. Directly; the carrier is bound by the situation (having forgot the direct opening number) to the freedom of submissional reciprocity. Thus the carrier is bound to require the official to be submissive in order for the carrier to submit to the official's demands for a search of the case.

This makes the process of opening the case a collaborative process rather than one in which a carrier is just following orders.

Moreover, a person wishing to search the briefcase may also be inclined to want to search the mailroom facility. Such a person can be directed to the entrance of the secure mailroom facility, and instructed to use the enterphone to summon a same-sex decontamination officer to remotely unlock the entrance. In this way all visitors to the facility are screened, even after-hours or when the facility would normally be closed.

Since the briefcase can now be safely carried without being searched by strangers (e.g escaped convicts who might be wearing a stolen police uniform, or the like), it can be safely carried to the intended recipient of a package enclosed therein.

The fingerprint scanners 430 form path RT of FIG. 1. Additionally, it is preferable that path RT of FIG. 1 further include a video camera borne by the carrier.

Additionally, a person can be photographed and fingerprinted by being named or designated as a package recipient!

Various other combinations are possible within the scope of the invention and appended claims. Various numbers of stages may be used, with or without drying room, with or without undressing room, and with various kinds of circumvention preventers such as turnstiles, one-way passages, machine vision or radar controlled passages, or the like.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations.

References to “processor”, or “computer” shall include sequential instruction, parallel instruction, and special purpose architectures such as digital signal processing hardware, Field Programmable Gate Arrays (FPGAs), programmable logic devices, as well as analog signal processing devices.

References to “circumvention preventer”, shall include not only hard limits like turnstiles, airlock doors, magnetic locks, and solenoid locked doors, but shall also include soft limits like means for producing gradient discomfort in response to circumvention, gradient discomfort in response to nonprogressive movement or nonprogress in a decontamination procedure, or the like. The term “circumvention preventer” will also be taken to mean a soft or continuously variable degree of decontaminational service that is responsive to aspects of the degree of movement of persons in the shower of the facility, or the velocity of travel of persons through a shower portion of the facility.

References to “contamination”, “contaminated”, “contaminant”, etc., shall include any matter of an undesired nature., or possible exposure to such matter. A person may be said to be “contaminated” when the person

is carrying nuclear, biological, or chemical (NBC) warfare materials;

has possibly been exposed to NBCs;

is a victim of a terrorist attack in which NBCs were used;

is possibly carrying radioactive materials;

has possibly been exposed to radioactive materials;

is a victim of a chemical spill;

is a victim of an accident involving hazardous materials;

has had possible exposure to radioactive materials;

is not clean when about to enter a facility, such as an emergency room of a hospital, or a microprocessor fabrication facility, or other similar clean room, where cleanliness is a desired attribute;

is wearing clothing in a situation where clothing would interfere with decontamination;

is wearing street clothing in a situation where the person should only be wearing a properly cleaned uniform;

is wearing street clothing in a place such as a pool, where the person should only be wearing a clean bathingsuit;

is wearing a bathing suit in an area such as a spa., sauna, steamroom; or other area where bathing suits are not permitted;

is wearing shoes in pool or spa areas, or other places where shoes are not permitted;

has come from a toilet area and is heading toward a pool area, or the like, without having had a shower, notwithstanding the fact that the person may or may not have actually used a toilet;

has come from a sauna area and is heading toward a pool area without having had a shower;

is carrying a gun in areas where guns are not permitted;

is carrying a weapon in areas where weapons are not permitted;

is carrying a cellular telephone in areas where cellular telephones are not permitted;

is wearing a computer in areas where computers are not permitted;

is wearing any particular item in areas where wearing that particular item is not permitted;

has possession of any particular item in areas where possession of that particular item is not permitted;

has been exposed to narcotics in areas where narcotics are not desired;

has been exposed to alcohol in areas where the person should be sober;

has been exposed to a substance in areas where that substance is not desired;

has been on a farm within a certain specified period of time;

has walked upon the ground, or earth, and was not since decontaminated;

has possession of confidential documents upon leaving a secure premises where confidential documents should not be taken;

has possession of information storage media upon leaving a secure premises where confidential information exists.

has munitions, such as shoulder mounted rocket launchers, portable nuclear weapons, encryption programs written or printed on paper or stored on floppy disks or the like, or seeing aids such as night vision goggles for seeing in low light conditions such as photographic darkrooms or poorly lit corridors;

has ingested, or is otherwise carrying within the body, matter that is unacceptable for bringing into or out of a certain area;

is disease carrying.

The term “contaminant” includes that which causes a person to be said to be “contaminated”, as defined in the above list. The process of “decontamination” can refer to the process of removing from the person, or forcing or requiring or otherwise causing the person to remove, any of the above mentioned contaminants. When contaminants refer to possible exposure to a substance, chemical, radiation, or the like, the process of decontamination includes taking steps, such as showering those so exposed, e.g. steps that assume the exposure has happened. When contaminants arc items such as clothing, munitions, cellular telephones, or the like, the process of decontamination includes causing persons to remove these contaminants and, for example, place the contaminants in bags, and then step away from the bags and enter another room through a means to prevent the persons from getting back to the contaminants. When contaminants are in-body, ingested, or of such nature as to require time before they or their absence may become evident, the process of decontamination may include quarantine or other detention under medical surveillance, or in which disease or waste products may be given sufficient time to pass through the body, or in which sufficient time may pass as to determine that contaminants do not exist or do not pose a threat to the safety or security of other persons or organizations. The process of decontamination may also include means for detecting contaminants within or about a person's body, and causing the person to remove, possibly through the passage of time, these contaminants. A “decontaminator” is a system, means and apparatus, or embodiment of an invention, for carrying out this process of decontamination.

The abbreviation “decon” generally means decontaminate, or decontamination, or the like. Exactly which of these words that “decon” stands for is inferred by the rest of the sentence or context it is used in.

From the foregoing description, it will thus be evident that the present invention provides a design for a decontaminator with circumvention preventer. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

The embodiments of the invention in which I claim an exclusive property or privilege are defined as follows:

1. A method of delivering a package, said method comprising the steps of
placing said package in a case;
locking said case;
taking said case to a recipient of said package;
providing said recipient with an articulable basis upon which to believe that a recipient biometric is required to receive said package.

2. A method of fingerprinting a person, said method comprising the steps of designating said person as a package recipient, and delivering a package to said person using the method of claim 1.

3. A method of delivering a package, said method comprising the steps of
providing a carrier with said package;
providing said carrier with means for incidentalist picture capture;
sending live pictures of a recipient of said package to a remote facility.

4. A delivery system comprising:
a case for carrying a package;
a lock for said case;
means for constructing an articulable basis upon which a recipient may believe that a recipient biometric is required to receive said package.

5. A delivery system comprising.
a delivery uniform comprising a wearable computer system, said uniform also including an image capture system, said wearable computer system responsive to an output of said image capture system;
a wireless communications link to a remote facility;
a server for connection to a sender of a package sent by said delivery system.

6. A vaccination facility comprising:
an entrance to a facility;
a turnstile for allowing a person to enter said entrance but not leave from said entrance;
a vaccinator;
an exit operable only in response to the receiving of a vaccination from said vaccinator.

7. A suspect selector comprising
an entrance to a facility;
a turnstile for allowing a person to enter said entrance but not leave from said entrance;
movable panels for said turnstile;
an exit operable only in response to the moving of at least one of said panels together with said turnstile.

8. A method of crowd control, said method comprising the steps of:
spraying persons with a chemical contaminant;
offering said persons an opportunity to decontaminate themselves using a decontamination facility including the vaccination facility described in claim 6 or claim 7.
